(19) United States
(12) Patent Application Publication
(10) Pub. No.: US 2009/0184483 A1
(43) Pub. Date: Jul. 23, 2009

(54) MULTI-RIDER SCOOTER

(76) Inventor: Ron Steinberg, Las Vegas, NV (US)

Correspondence Address: GREENBERG TRAURIG, 3773 HOWARD HUGHES PARKWAY, SUITE 500 NORTH, LAS VEGAS, NV, 89169, US

(21) Appl. No.: 12/351,217

(22) Filed: Jan. 9, 2009

Related U.S. Application Data
(60) Provisional application No. 61/020,349, filed on Jan. 10, 2008.

(51) Int. Cl. B62M 1/00

(52) U.S. Cl. 280/87.041; 180/219

(57) ABSTRACT

A scooter for transporting one or more persons. The scooter has a base wherein at least two handlebar members are disposed about a portion of the base with one operable to support a driver and steer the scooter, and a second operable to support a passenger. One or more seat members may also be disposed about the base for accommodating riders.

### CROSS REFERENCE TO RELATED APPLICATION

This application claims the benefit of U.S. Provisional Application No. 61/020,349 filed Jan. 10, 2008.

### FIELD OF THE INVENTION

The embodiments of the present invention relate to a scooter capable of transporting one or more persons.

### BACKGROUND

Vehicles for transporting people are known in the prior art. The use of powered scooters has been gaining popularity with children and adults because they provide convenience, efficient gas mileage and require no license. However, scooters accommodate only a single rider. Accordingly, children take risks by operating single person scooters with multiple children onboard. Indeed, many adults do the same.

As such, there exists a need for a scooter having a combination of features and functionalities such that the scooter is capable of safely transporting one or more persons.

### SUMMARY

Accordingly, a first embodiment of the present invention is a vehicle for transporting one or more persons comprising: a base; a first handlebar member extending upward near a front portion of said base, wherein said first handlebar member is operable to steer said scooter; a second handlebar member extending upward from said base rear of said first handlebar member; a front wheel positioned near said first handlebar member and operatively controlled thereby; and a rear wheel coupled substantially near a rear portion of said base.

In one embodiment, the first and second handlebar members may be adjusted to the height of a driver and passenger. In another embodiment, the first and second handlebar members are collapsible for transport or storage. In other embodiments, sitting means and non-slip sheets of material may be disposed about an upper surface of said base. In other instances, a third wheel is controlled by said second handlebar member to provide additional navigational control. Although the scooter may be self-propelled, in other embodiments a motorized engine is disposed near the rear wheel for automatically propelling the scooter.

Other variations, embodiments and features of the present invention will become evident from the following detailed description, drawings and claims.

### BRIEF DESCRIPTION OF THE DRAWINGS

FIG. 1 illustrates a perspective view of a multi-rider scooter according to a first embodiment of the presently disclosed invention;

FIG. 2 illustrates a perspective view of a multi-rider scooter according to a second embodiment of the presently disclosed invention;

FIGS. 3-4 illustrate perspective and side views of a multi-rider scooter according to a third embodiment of the presently disclosed invention; and

FIGS. 5-6 illustrate perspective and side views of a multi-rider scooter according to a fourth embodiment of the presently disclosed invention.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

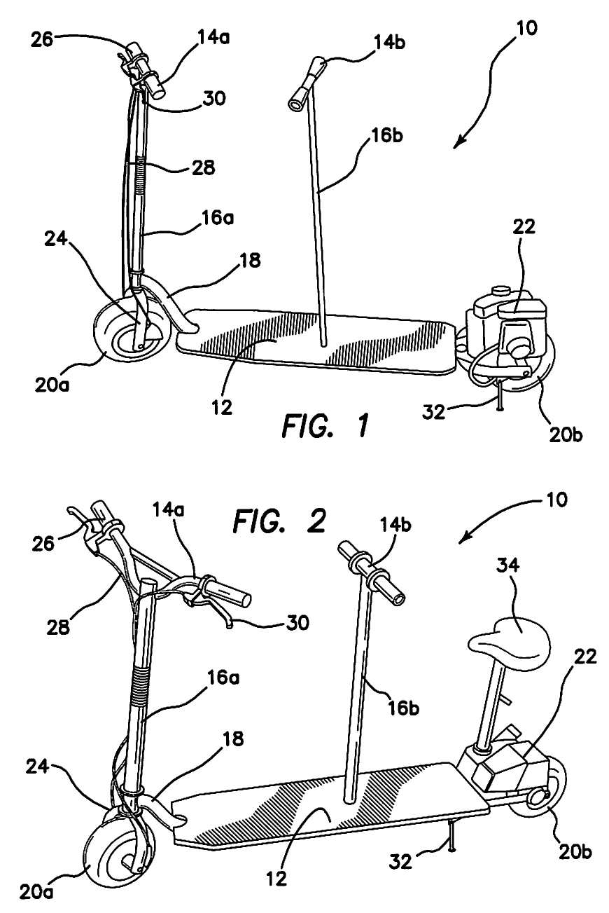

Initial reference is made to FIG. 1 illustrating a perspective view of a multi-rider scooter 10 according to a first embodiment of the present invention. The scooter 10 includes a rectangular shaped base 12 capable of supporting one or more persons. In other embodiments, the base 12 can be fabricated having other polygonal shapes and sizes. In this embodiment, the base 12 is constructed of wood, metal, plastic or other suitable material. A first handlebar member 14a is coupled near the front of the base 12 while a second handlebar member 14b is coupled near a central portion of the base 12 with both handlebar members 14a, 14b including poles 16a, 16b. Pole 16a is coupled to an extension member 18 extending from said base 12 while pole 16b is coupled to the base 12 using known fasteners including screws, rivets, bolts or other suitable fastening means. Like the base 12, the handlebar members 14a, 14b, including the poles 16a, 16b, can be constructed of wood, metal, plastic or other suitable material. Although two handlebar members 14a, 14b are shown in this embodiment, three or more handlebar members may be incorporated in other embodiments, with the additional handlebar members being disposed along the base 12.

In one embodiment, each of the poles 16a, 16b includes telescopic means allowing the height of the poles 16a, 16b to be adjusted to accommodate riders of various heights. In another embodiment, the poles 16a, 16b are collapsible along a hinge (not shown) near a lower portion. The collapsibility of the poles 16a, 16b allows for ease of transport and storage.

As shown, a front wheel 20a is coupled near a lower end of the first pole 16a and handlebar 14a adjacent the front portion of the base 12, while a rear wheel 20b is coupled near the rear portion of the base 12. A U-shaped bracket 24 operatively joins the front wheel 20a to the pole 16a such that handlebar 14a can be used to steer the scooter 10. Those skilled in the art will recognize that brackets with other shapes can be used. Although two wheels 20a, 20b are shown in this embodiment, three or more wheels 20 may be incorporated in other embodiments, with the additional wheels 20 being disposed along the length of the base 12. Such additional wheels being used primarily for weight support rather than control. However, it is conceivable that additional wheels can be linked to the front wheel 20a and rear wheel 20b to provide control as well.

In operation, the scooter 10 is controlled by the front handlebar member 14a while the rear handlebar member 14b essentially provides support for the passenger. In other embodiments, a third wheel (not shown) may be disposed near a lower end of the second pole 16b and coupled to and controlled by the handlebar member 14b in unison with the handlebar member 14a.

A throttle member 26 is integrated with handlebar member 14a along with a brake unit 30. Cables 28 join the throttle member 26 and brake unit 30 to a motorized engine 22, near the rear of the scooter 10, and brake pads, respectively. The motorized engine 22 can be powered by gas or electricity. In this embodiment, the cables 28 for controlling the motorized engine 22 run along the pole 16 and an underside surface of the base 12 to the engine 22 and brakes. Although no throttle member 26, brake unit 30 and cables 28 are shown for the handlebar member 14b, it is understood that corresponding components may be incorporated therewith in other embodiments. In this embodiment, the scooter 10 also includes a kickstand 32 for keeping the vehicle 10 upright when not in use.

With manual operation, a driver and passenger grasp the handlebar members 14a, 14b with both hands, rest one foot on the base 12 of the scooter 10, and use their other leg and foot to make pushing contact with the road surface repeatedly in order to propel the scooter 10 in the forward direction. When riders wish to slow down or stop, the driver and passenger either stop pushing the scooter 10 or engage the brake unit 30. It is understood by one skilled in the art that the scooter 10 can accommodate one, two or more riders, in standing or seated positions. Seat means (not shown) may extend vertically and substantially upward from the upper surface of the base 12 for riders interested in operating the scooter 10 while in a seated position and will become more apparent in subsequent figures and discussion.

With powered operation, a driver and passenger grasp the handlebar members 14a, 14b and rest both legs on the base 12 of the scooter 10. To move in the forward direction, the driver actuates the throttle member 26 thereby engaging the motorized engine 22 near the back wheel 20b. The throttle member 26 allows the driver to control the acceleration of the scooter 10 and therefore the speed at which the vehicle 10 travels. When the driver and passenger wish to slow down or stop, the driver and/or passenger either engage the brake unit 30 or let up on the throttle member 26 and wait for the scooter 10 to slow down due to frictional forces.

In some instances, to facilitate contact between feet or the driver and passenger, an upper surface of the base 12 is covered with grip tape or a similar material (e.g., anti-slip coatings or silicon adhesive material).

Reference is now made to FIG. 2 illustrating a perspective view of a multi-rider scooter 10 according to a second embodiment of the presently disclosed invention. Like the first embodiment, the scooter 10 in this embodiment includes a base 12 coupled to a pair of handlebar members 14a, 14b with corresponding extendable and/or collapsible poles 16a, 16b. The pole 16a is coupled to an extension member 18 extending from the base 12 while a U-shaped bracket 24 operatively joins a front wheel 20a to the pole 16a such that handlebar 14a can be used to steer the scooter 10. Throttle member 26 and brake unit 30 along with corresponding cables 28 are disposed about the handlebar 14a for manipulating the scooter 10 in similar fashion as previously described. An electric or gas powered engine 22 is disposed near the rear of the base 12 along with a rear wheel 20b. A kickstand 32 may be coupled to the base 12 for keeping the vehicle 10 upright.

In this embodiment, a seating means 34 such as a chair may extend vertically and substantially upward from the frame of the engine 22 to provide a driver with a place to sit if the driver wishes to operate the vehicle 10 while in a seated position. In other embodiments, the seat means 34 may extend vertically and substantially upward from the rear of the base 12 or along any portion of the base 12. In some instances, a seating means (not shown) may be integrated with the handlebar member 14b as to provide a chair for a driver to sit while utilizing the front handlebar 14a.

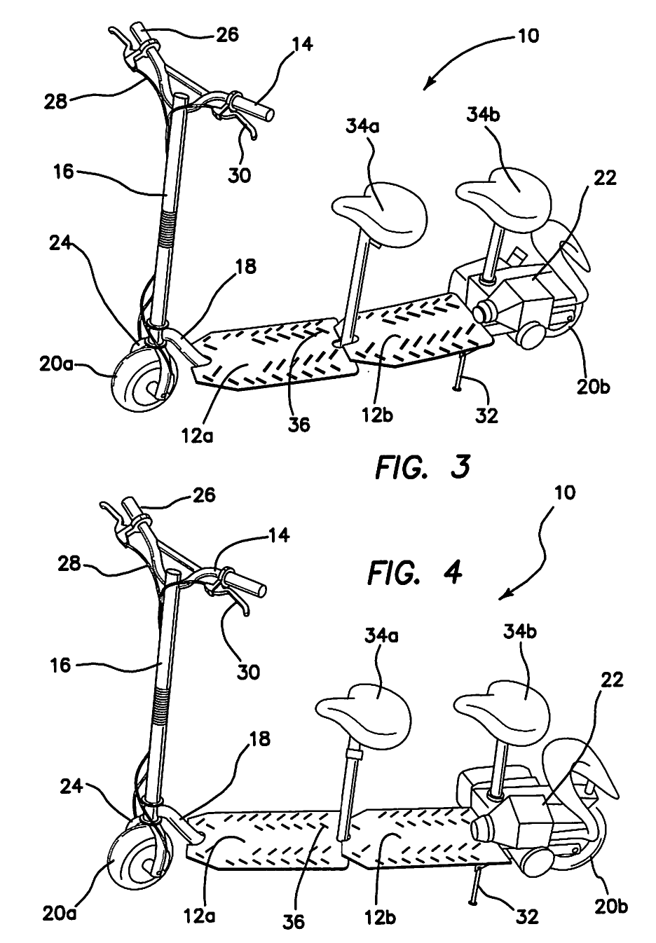

Reference is now made to FIGS. 3-4 illustrating perspective and side views of a multi-rider scooter 10 according to a third embodiment of the presently disclosed invention. Like previous embodiments, the scooter 10 in this embodiment includes a first base section 12a modularly coupled to a second base section 12b to form a single base platform for the scooter 10. A handlebar member 14 with corresponding extendable and/or collapsible pole 16 can be coupled to a front section of the base 12a. The pole 16 is coupled to an extension member 18 extending from the base 12a while a U-shaped bracket 24 operatively joins a front wheel 20a to the pole 16 such that the handlebar 14 can be used to steer the scooter 10. Throttle member 26 and brake unit 30 along with corresponding cables 28 are disposed about the handlebar 14 for manipulating the scooter 10 in similar manner as previously described. An electric or gas powered engine 22 is disposed near the rear section of the base 12b along with a rear wheel 20b. A kickstand 32 may be coupled to the rear section of the base 12b for keeping the vehicle 10 upright.

In this embodiment, a first seating means 34a extends vertically and substantially upward from a central portion of the base in between the two sections 12a, 12b, while a second seating means 34b extends vertically and substantially upward from the frame of the engine 22 to provide chairs for riders to sit while operating the vehicle 10. In other embodiments, the seat means 34a, 34b may be a bench that runs along the length of the base 12 to accommodate additional riders. In other embodiments, a sissy bar (not shown) may be incorporated near the rear of the scooter 10 adjacent the rear seating means 34b and the engine 22 as a handlebar means for the passenger in the rear.

In this embodiment, each section of the base 12a, 12b includes a plurality of apertures 36 disposed about the body of the base 12a, 12b for improved aerodynamics. In other embodiments, additional base sections 12 (not shown) may be coupled to the existing sections 12a, 12b along with additional seating means 34 to provide a multi-rider scooter 10 capable of transporting three or more riders. It will be understood by one skilled in the art that although the base sections 12a, 12b are modularly coupled, these sections 12a, 12b may be integrated into a single unit with suitable fastening means including screws, bolts and rivets.

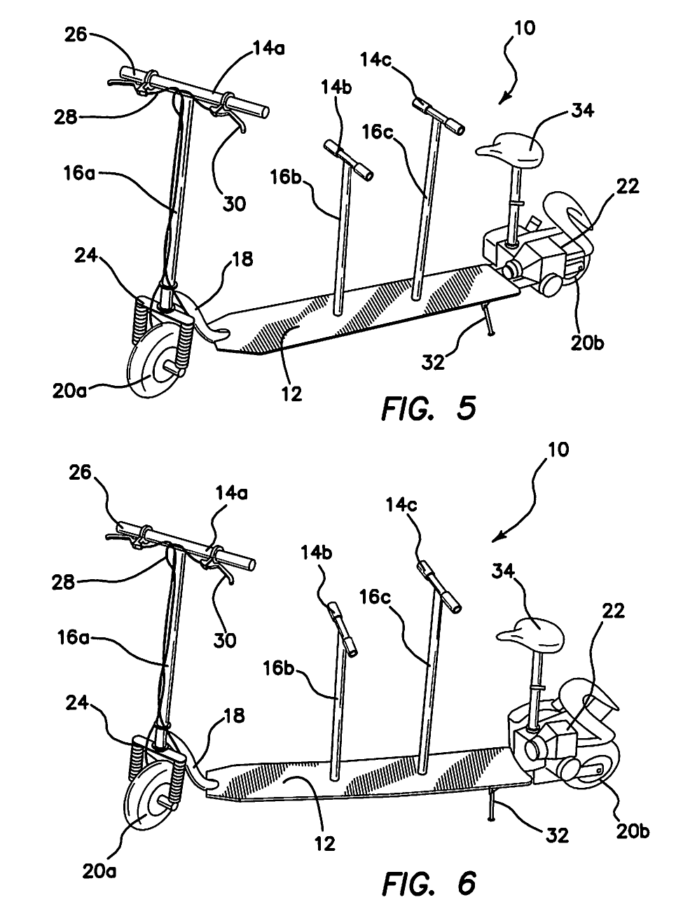

Reference is now made to FIGS. 5-6 illustrating perspective and side views of a multi-rider scooter 10 according to a fourth embodiment of the presently disclosed invention. Like previous embodiments, the scooter 10 in this embodiment includes a base 12 coupled to a plurality of handlebar members 14a, 14b, 14c with corresponding extendable and/or collapsible poles 16a, 16b, 16c. The pole 16a is coupled to an extension member 18 extending from the base 12 while a U-shaped bracket 24 operatively joins a front wheel 20a to the pole 16a such that handlebar 14a can be used to steer the scooter 10. In this embodiment, the U-shaped bracket 24 includes suspension or springing mechanism so as to minimize any bumps that a rider may encounter on the road. Throttle member 26 and brake unit 30 along with corresponding cables 28 are disposed about the handlebar 14a for manipulating the scooter 10 in similar manner as previously described. An electric or gas powered engine 22 is disposed near the rear of the base 12 along with a rear wheel 20b. A kickstand 32 may be coupled to the base 12 for keeping the vehicle 10 upright.

In this embodiment, a seating means 34 such as a chair may extend vertically and substantially upward from the frame of the engine 22 to provide a driver with a place to sit if the driver wishes to operate the vehicle 10 while in a seated position. In other embodiments, additional seat means 34 may extend vertically and substantially upward from the rear of the base 12 or along the length of the base 12. In some instances, additional seating means (not shown) may be integrated with other handlebar members 14b, 14c as to provide a place for the other riders to sit while utilizing the handlebar members 14a, 14b, respectively.

Although the invention has been described in detail with reference to several embodiments, additional variations and modifications exist within the scope and spirit of the invention as described and defined in the following claims.

I claim:

1. A scooter for transporting one or more persons comprising:
a base;
a first handlebar member extending upward near a front portion of said base, wherein said first handlebar member is operable to steer said scooter;
a second handlebar member extending upward from said base rear of said first handlebar member;
a front wheel positioned near said first handlebar member and operatively controlled thereby; and
a rear wheel coupled substantially near a rear portion of said base.

2. The scooter of claim 1 further comprising non-slip material disposed about an upper surface of said base.

3. The scooter of claim 1 further comprising a central wheel coupled to a lower end of said second handlebar member.

4. The scooter of claim 1 wherein said first and second handlebar members are adjustable in a vertical direction.

5. The scooter of claim 1 wherein said handlebar members are collapsible.

6. The scooter of claim 1 further comprising a motorized engine.

7. The scooter of claim 1 further comprising one or more seats supported by said base.

8. A scooter for transporting one or more persons comprising:
a base;
a first handlebar member extending upward near a front portion of said base, wherein said first handlebar member is operable to steer said scooter via a front wheel;
at least two seat members supported by said base rear of said first handlebar member; and
a rear wheel coupled substantially near a rear portion of said base.

9. The scooter of claim 8 further comprising non-slip material disposed about an upper surface of said base.

10. The scooter of claim 8 further comprising a central wheel coupled to a lower end of said second handlebar member.

11. The scooter of claim 8 wherein said first handlebar member is adjustable in a vertical direction.

12. The scooter of claim 8 wherein said handlebar member is collapsible.

13. The scooter of claim 8 further comprising a motorized engine.

14. The scooter of claim 8 further comprising a second handlebar member rear of said first handlebar member and forward of said second handlebar member.
